(19) United States
(12) Patent Application Publication
(10) Pub. No.: US 2021/0185562 A1
(43) Pub. Date: Jun. 17, 2021

(54) RADIO COMMUNICATION DEVICE, RADIO COMMUNICATION SYSTEM, AND RADIO COMMUNICATION METHOD

(71) Applicant: NEC CORPORATION, Tokyo (JP)

(72) Inventor: Takuji IIZUKA, Tokyo (JP)

(73) Assignee: NEC CORPORATION, Tokyo (JP)

(21) Appl. No.: 17/117,775

(22) Filed: Dec. 10, 2020

(30) Foreign Application Priority Data
Dec. 13, 2019 (JP) 2019-225333

(51) Int. Cl. H04W 28/06; H04W 68/00; H04W 28/02

(52) U.S. Cl. CPC H04W 28/065; H04W 28/0278; H04W 28/0236; H04W 68/005

(57) ABSTRACT

A radio communication device, a radio communication system, and a radio communication method capable of notifying a radio communication unit of retention information of divided packets retained in a radio communication unit and allocating the divided packets based on the notification are provided. A radio communication device 100 includes radio transmission units 120A and 120B including buffers 122A and 122B, respecitvely, for storing a transmission packet to be transmitted, a division unit 112 configured to divide an input packet into a plurality of transmission packets, a retention information notification unit 124 configured to notify about retention information of the transmission packets retained in the buffers 122A and 122B, and an allocation unit 113 configured to allocate the transmission packets to at least one of the plurality of radio transmission units 120A and 120B based on the notified retention information.

### INCORPORATION BY REFERENCE

This application is based upon and claims the benefit of priority from Japanese patent application No. 2019-225333, filed on Dec. 13, 2019, the disclosure of which is incorporated herein in its entirety by reference.

### TECHNICAL FIELD

The present disclosure relates to a radio communication device, a radio communication system, and a radio communication method. In particular, the present disclosure relates to a radio communication device, a radio communication system, and a radio communication method using a plurality of wireless lines.

### BACKGROUND ART

A Link Aggregation technique may be used in order to widen the transmission bandwidth between radio communication devices. The link aggregation technique is a technique that virtually bundles a plurality of physical lines into one line and enables use of bandwidth depending on a total number of the bands of the physical lines.

International Patent Publication No. WO2018/116965 discloses a radio communication device that bundles a plurality of radio communication means to transmit packets. The radio communication device described in International Patent Publication No. WO2018/116965 divides a packet into a plurality of divided packets and allocates the divided packets to radio communication means having a minimum radio transmission delay. When the radio transmission delay is calculated, it is necessary to consider the number of divided packets retained in the radio communication means. The number of divided packets retained in the radio communication means can be calculated based on the number of allocated divided packets and so on.

### SUMMARY

As described above, in order to properly allocate divided packets to a plurality of radio communication means, it is necessary to acquire the exact number of divided packets retained in the radio communication means. However, there has been a problem that the number of divided packets retained in the radio communication means cannot be accurately calculated, and thus the divided packets cannot be appropriately allocated.

An object of the present disclosure is to provide a radio communication device, a radio communication system, and a radio communication method capable of notifying a radio communication unit of retention information of divided packets retained in a radio communication unit and allocating the divided packets based on the notification.

An example object of the present disclosure is a radio communication device including: a plurality of radio transmission means each including a buffer for storing a transmission packet to be transmitted; division means for dividing an input packet into a plurality of transmission packets; retention information notification means for notifying about retention information of the transmission packets retained in the buffer; and allocation means for allocating the transmission packets to at least one of the plurality of radio transmission units based on the notified retention information.

In another example aspect of the present disclosure, a radio communication system includes: a first radio communication device that includes a plurality of radio transmission means each including a buffer for storing a transmission packet to be transmitted, division means for dividing an input packet into a plurality of transmission packets, retention information notification means for notifying about retention information of the transmission packets retained in the buffer, and allocation means for allocating the transmission packets to at least one of the plurality of radio transmission units based on the notified retention information; and a second radio communication device that includes plurality of radio reception means for receiving the transmission packets transmitted by the plurality of radio transmission units, and an assembly means for reproducing the packet from the transmission packets.

In another example aspect of the present disclosure, a radio communication method includes: dividing an input packet into a plurality of transmission packets; notifying about retention information of the transmission packets retained in a buffer for storing the transmission packets; and allocating the transmission packets to at least one of a plurality of radio transmission means each including a buffer based on the notified retention information.

### BRIEF DESCRIPTION OF DRAWINGS

The above and other objects, features and advantages of the present disclosure will become more fully understood from the detailed description given hereinbelow and the accompanying drawings which are given by way of illustration only, and thus are not to be considered as limiting the present disclosure.

FIG. 1 is a block diagram showing a configuration example of a radio communication system 300 according to a first example embodiment;

FIG. 2 is a block diagram showing a functional configuration of a radio communication device 100 according to the first example embodiment;

FIG. 3 is a block diagram showing a configuration of a radio communication system 300 according to a second example embodiment;

FIG. 4 is a block diagram showing a configuration of a radio communication device 100 according to the second example embodiment;

FIG. 5 is a block diagram showing a configuration of a radio communication device 200 according to the second example embodiment;

FIG. 6 is an overview diagram schematically showing generation of divided packets according to the second example embodiment;

FIG. 7 is a diagram showing an example of a radio delay of the radio communication device 100 according to the second example embodiment;

FIG. 8 is a flowchart showing an operation of the radio communication device 100 according to the second example embodiment;

FIG. 9 is a flowchart showing an operation for managing a retention amount of a packet buffer;

FIG. 10 is an overview diagram showing an overview of overheads of divided packets;

FIG. 11 shows a change in a retention amount of a packet buffer;

FIG. 12 is an overview diagram showing a method for allocating the divided packets based on a radio transmission delay;

FIG. 13 is a block diagram showing a configuration of a radio communication device 100 including three radio transmission means;

FIG. 14 is a block diagram showing a configuration of a radio communication device 200 including three radio reception means; and

FIG. 15 is a flowchart showing a method for allocating divided packets among to three radio communication means.

### EMBODIMENTS

### First Example Embodiment

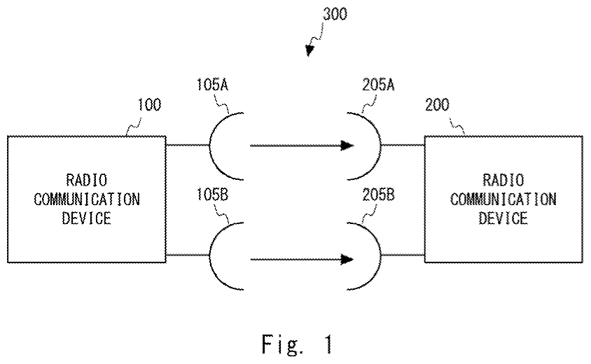

FIG. 1 is a block diagram showing a configuration example of a radio communication system 300 according to a first example embodiment. A radio communication system 300 includes a radio communication device 100 and a radio communication device 200. The radio communication device 100 includes an antenna 105A and an antenna 105B. The radio communication device 200 includes an antenna 205A and an antenna 205B. The radio communication device 100 divides an input packet into a plurality of transmission packets and transmits the transmission packets from the antennas 105A and 105B. The radio communication device 200 receives the transmission packets from the antennas 205A and 205B and reproduces the packets from the transmission packets.

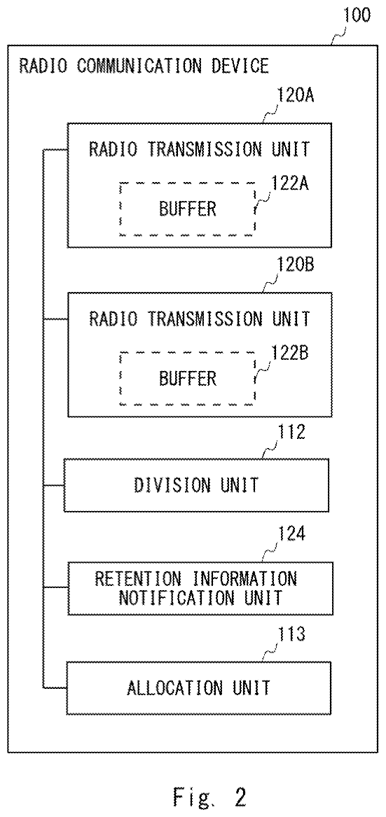

FIG. 2 is a block diagram showing a functional configuration of the radio communication device 100 according to the first example embodiment. The radio communication device 100 includes radio transmission units 120A and 120B, a division unit 112, a retention information notification unit 124, and an allocation unit 113.

The radio transmission unit 120A includes a buffer 122A. The buffer 122A stores the transmission packets. The radio transmission unit 120B includes a buffer 122B. The buffer 122B stores the transmission packets. The radio transmission unit 120A and the radio transmission unit 120B transmit the transmission packets allocated by the allocation unit 113, which will be described later, to the outside. The transmission packets allocated by the allocation unit 113 may be retained in the buffers 122A and 122B.

The division unit 112 divides the input packet into a plurality of transmission packets. The retention information notification unit 124 notifies the retention information of transmission packets retained in the buffers 122A and 122B of the radio transmission unit 120A and 120B. The retention information of the transmission packets is, for example, the number of transmission packets, the amount of data, and so on. The retention information may be a ratio of a used area of the storage areas of the buffers 122A and 122B. The retention information notification unit 124 notifies the allocation unit 113 ,which will be described later, of the above information.

The retention information notification unit 124 may notify the retention timing information related to a timing at which the retention information of the radio transmission unit 120A or the radio transmission unit 120B is acquired to the allocation unit 113 described later. The retention information notification unit 124 may notify the allocation unit 113 of the retention information when the retention information exceeds a predetermined threshold. The retention information notification unit 124 may notify the allocation unit 113 of the retention information when the radio transmission speed of the radio transmission unit 120A or the radio transmission unit 120B decreases.

The allocation unit 113 allocates the transmission packets to the radio transmission unit 120A or the radio transmission unit 120B based on the retention information notified by a retention information notification unit 124. For example, the allocation unit 113 calculates, based on the notified retention information, a radio transmission delay caused by passing through the radio transmission unit 120A and a radio transmission delay caused by passing through the radio transmission unit 120B. The allocation unit 113 allocates the transmission packets to one of the radio transmission units 120A and 120B having a smaller radio transmission delay. Note that the allocation unit 113 may allocate the transmission packets to both the radio transmission unit 120A and the radio transmission unit 120B.

When the retention information notification unit 124 notifies about the retention timing information related to the timing at which the retention information of the radio transmission unit 120A is acquired, the allocation unit 113 may calculate the retention amount of the buffer 122A based on the retention information, the number of transmission packets allocated to the radio transmission unit 120A from the timing onward, and the quantity of transmission packets transmitted by the radio transmission unit 120A from the timing onward. The allocation unit 113 can update the radio transmission delay of the radio transmission unit 120A based on the retention amount of the packet buffer 122A.

According to this example embodiment, the retention information notification unit 124 notifies the allocation unit 113 of the retention information of the transmission packets retained in the radio transmission unit 120A or the radio transmission unit 120B. This enables the radio communication device 100 according to this example embodiment to allocate the transmission packets to the radio transmission unit 120A or the radio transmission unit 120B based on the notified retention information.

### Second Example Embodiment

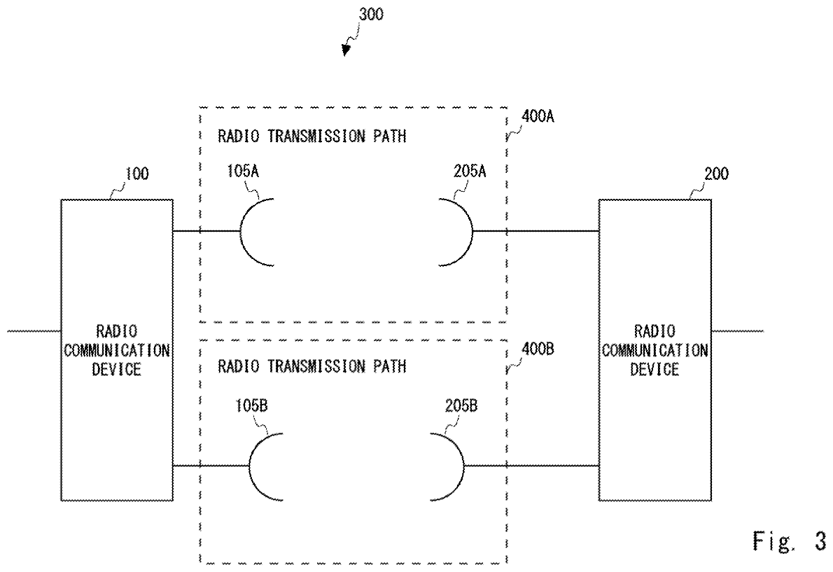

FIG. 3 is a block diagram of a radio communication system 300 according to this example embodiment. The radio communication system 300 includes a radio communication device 100 and a radio communication device 200. The radio communication device 100 performs radio communication with a radio communication device 200 via a radio transmission path 400A. The radio transmission path 400A is a radio transmission path between the antenna 105A of the radio communication device 100 and an antenna 205A of the radio communication device 200. The radio communication device 100 performs radio communication with the radio communication device 200 via a radio transmission path 400B. The radio transmission path 400B is a radio transmission path between the antenna 105B of the radio communication device 100 and the antenna 205B of the radio communication device 200.

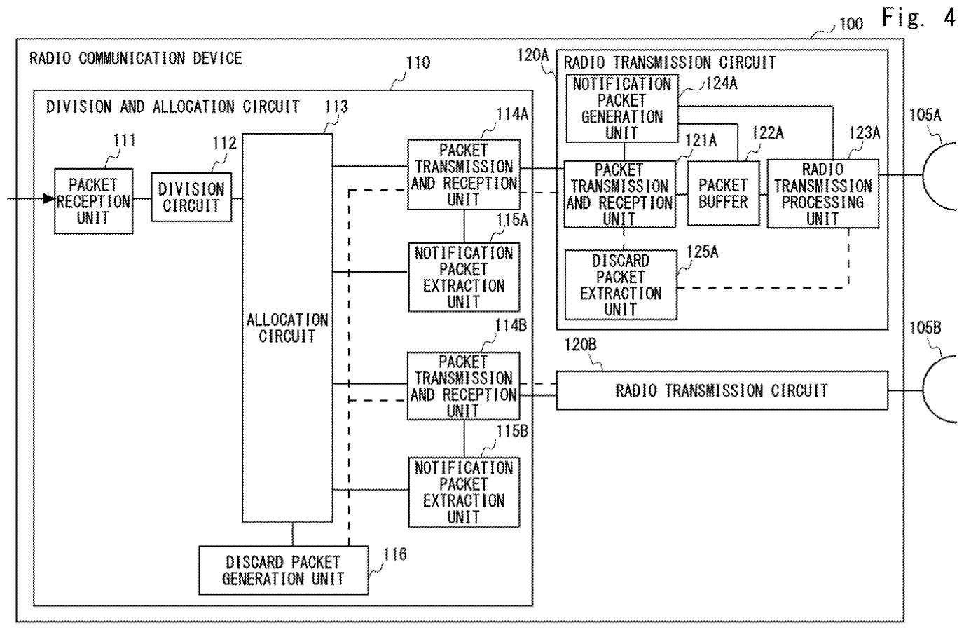

FIG. 4 is a block diagram showing a configuration of the radio communication device 100 according to the second example embodiment. The radio communication device 100 performs radio transmission. The radio communication device 100 includes a division and allocation circuit 110, a radio transmission circuit 120A, and a radio transmission circuit 120B. The division and allocation circuit 110 and the radio transmission circuit 120A are connected by a serial interface. The division and allocation circuit 110 and the radio transmission circuit 120B are connected by a serial interface.

The division and allocation circuit 110 divides an input packet into a plurality of divided packets and allocates the divided packets to the radio transmission circuit 120A or the radio transmission circuit 120B. The divided packet is also referred to as a transmission packet.

The radio transmission circuit 120A has a higher radio transmission speed than that of the radio transmission circuit 120B, and is a radio transmission circuit that is mainly used. The radio transmission circuit 120A is referred to as a main radio transmission circuit, and the radio transmission circuit 120B is referred to as a sub radio transmission circuit. The radio transmission circuit 120A is also referred to as a radio transmission unit 120A. The radio transmission circuit 120B is also referred to as a radio transmission unit 120B.

The division and allocation circuit 110 includes a packet reception unit 111, a division circuit 112, an allocation circuit 113, packet transmission and reception units 114A and 114B, notification packet extraction units 115A and 115B, and a discard packet generation unit 116.

The packet reception unit 111 receives packets. The packet is, for example, an Ethernet packet. The packet reception unit 111 transmits the received packets to the division circuit 112.

The division circuit 112 is a circuit for dividing the packet. The division circuit 112 is also referred to as the division unit 112. The division circuit 112 divides a packet into packets with a specified size and generates divided packets. The division circuit 112 provides a sequence ID to the head of the divided packet as an overhead. The division circuit 112 transmits the divided packets to the allocation circuit 113. The operation of the division circuit 112 will be described later.

The allocation circuit 113 allocates the divided packets to the radio transmission circuit 120A or the radio transmission circuit 120B. The allocation circuit 113 is also referred to as the allocation unit 113. The allocation circuit 113 calculates the radio transmission delay of the radio transmission circuit 120A and the radio transmission delay of the radio transmission circuit 120B based on the retention delay and the radio transmission delay information. The allocation unit 113 allocates the divided packets to the radio transmission circuit 120 having a smaller radio transmission delay.

The retention delay used in the calculation of the radio transmission delay is a delay caused by the retention of divided packets in the packet buffers 122A and 122B, which will be described later. The radio transmission delay information used for the calculation of the radio transmission delay is a delay that does not include consideration over the retention of the retained divided packets. The radio transmission delay information includes, for example, a delay caused by a radio transmission path. The specific operation of the allocation circuit 113 will be described later.

The allocation circuit 113 generates discard information based on information from the notification packet extraction units 115, which will be described later, and transmits it to the discard packet generation unit 116. The discard information is a sequence ID of a divided packet to be discarded. The discard information is generated when the radio transmission delay is large. The case where the radio transmission delay is large is, for example, a case where the number of retained divided packets is large.

The packet transmission and reception unit 114A is an interface with the radio transmission circuit 120A. The packet transmission and reception unit 114A transmits the divided packets to the radio transmission circuit 120A. The packet transmission and reception unit 114A receives a notification packet, which will be described later, from the radio transmission circuit 120A. The packet transmission and reception unit 114A receives a discard packet from the discard packet generation unit 116, which will be described later, and transmits the discard packet to the radio transmission circuit 120A. The packet transmitted and received by the packet transmission and reception unit 114A is, for example, an Ethernet packet. The packet transmission and reception unit 114A transmits the notification packet to the notification packet extraction unit 115A. The packet transmission and reception unit 114A controls a transmission order of the divided packets and the discard packets.

The packet transmission and reception unit 114B is an interface with the radio transmission circuit 120B. The packet transmission and reception unit 114B transmits the divided packets to the radio transmission circuit 120B. The packet transmission and reception unit 114B receives the notification packet, which will be described later, from the radio transmission circuit 120B. The packet transmission and reception unit 114B receives the discard packet from the discard packet generation unit 116, which will be described later, and transmits the discard packet to the radio transmission circuit 120B. The packet transmitted and received by the packet transmission and reception unit 114B is, for example, an Ethernet packet. The packet transmission and reception unit 114B transmits the notification packet to the notification packet extraction unit 115B. The packet transmission and reception unit 114B controls the transmission order of the divided packets and the discard packets.

The notification packet extraction units 115A and 115B extract the notification packets from the packets received by the packet transmission and reception units 114A and 114B, respectively. The notification packet extraction unit 115A transmits information included in the notification packet to the allocation circuit 113. That is, the notification packet extraction unit 115 extracts retention timing information, retention information, and band information, which will be described later, from the notification packet, and notifies the allocation circuit 113 of them.

The discard packet generation unit 116 receives the discard information from the allocation circuit 113 and generates a discard packet. The discard packet generation unit 116 transmits the discard packet to the packet transmission and reception units 114A and 114B.

The radio transmission circuit 120A includes a packet transmission and reception unit 121A, a packet buffer 122A, a radio transmission processing unit 123A, a notification packet generation unit 124A, and a discard packet extraction unit 125A. The radio transmission circuit 120B has the same functional configuration as that of the radio transmission circuit 120A.

The packet transmission and reception unit 121A is an interface with the division and allocation circuit 110. The packet transmission and reception unit 121A receives the divided packet from the division and allocation circuit 110 and transmits it to the packet buffer 122A. The packet transmission and reception unit 121A transmits the notification packet generated by the notification packet generation unit 124A, which will be described later, to the division and allocation circuit 110. The packet transmission and reception unit 121A receives the discard packet from the division and allocation circuit 110 and transmits it to the discard packet extraction unit 125A. The packet transmitted and received by the packet transmission and reception unit 121A is, for example, an Ethernet packet.

The packet buffer 122A receives the divided packet from the packet transmission and reception unit 121A. The packet buffer 122A buffers the received divided packet.

The radio transmission processing unit 123A wirelessly transmits the divided packets from the antenna 105A. The radio transmission processing unit 123A may transmit a plurality of divided packets by multiplexing them on a radio frame. The radio transmission processing unit 123A receives the discard information from the discard packet extraction unit 125A, which will be described later, multiplexes the discard information as an overhead of the radio frame, and transmits the multiplexed information. The radio transmission processing unit 123A supports the adaptive modulation method and can change the radio communication band.

The notification packet generation unit 124A acquires the number of divided packets retained in the packet buffer 122A as the retention information. The notification packet generation unit 124A generates the notification packet by packetizing the retention information when the radio communication band of the radio transmission processing unit 123A is changed or when the retention information of the divided packet retained in the packet buffer 122A is changed. The notification packet generation unit 124A may include, in the notification packet, the band information indicating a radio communication band of the radio transmission processing unit 123A. The notification packet generation unit 124A transmits the generated notification packet to the packet transmission and reception unit 121A.

The discard packet extraction unit 125A extracts the discard packet from the packet received by the packet transmission and reception unit 121A. The discard packet extraction unit 125A extracts the discard information from the discard packet and transmits the discard information to the radio transmission processing unit 123A.

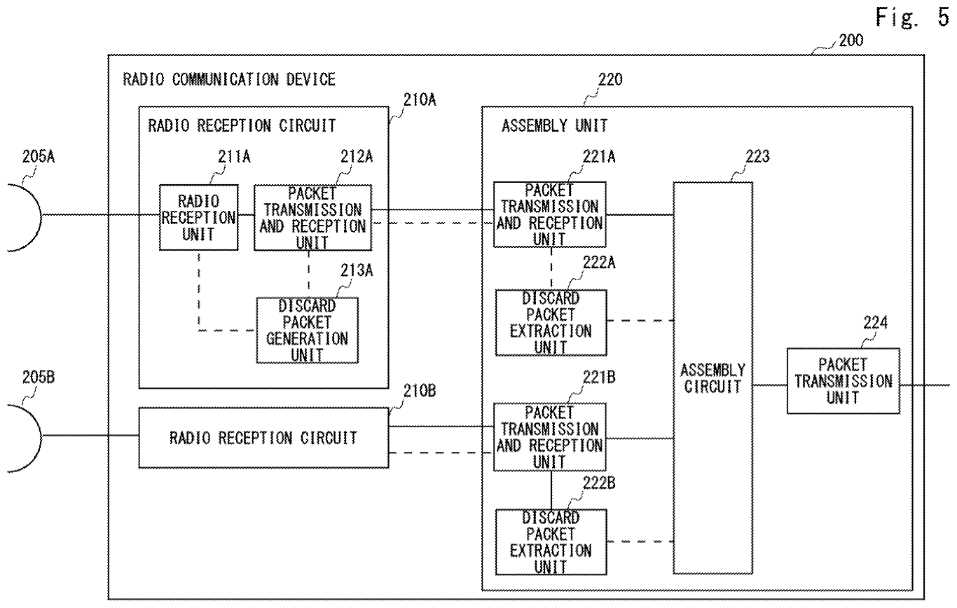

FIG. 5 is a block diagram showing a configuration of the radio communication device 200 according to the second example embodiment. The radio communication device 200 performs radio reception. The radio communication device 200 includes a radio reception circuit 210A, a radio reception circuit 210B, and an assembly unit 220. The radio reception circuit 210A and the assembly unit 220 are connected by a serial interface. The radio reception circuit 210B and the assembly unit 220 are connected by a serial interface.

The radio reception circuit 210A communicates with the radio transmission circuit 120A of the radio communication device 100. The radio reception circuit 210A includes a radio reception unit 211A, a packet transmission and reception unit 212A, and a discard packet generation unit 213A.

The radio reception unit 211A receives the radio frame and extracts the divided packet from the radio frame. The radio reception unit 211A transmits the divided packet to the packet transmission and reception unit 212A. The radio reception unit 211A extracts the discard information from the overhead of the radio frame. The radio reception unit 211A transmits the discard information to the discard packet generation unit 213A.

The packet transmission and reception unit 212A arbitrates the divided packets and the discard packets received from the discard packet generation unit 213A, which will be described later, and transmits the packets to the assembly unit 220. The packet to be transmitted is, for example, an Ethernet packet. The packet transmission and reception unit 212A is an interface with a packet transmission and reception unit 221A.

The discard packet generation unit 213A receives the discard information from the radio reception unit 211A. The discard packet generation unit 213A generates the discard packet by packetizing the discard information. The discard packet generation unit 213A transmits the discard packet to the packet transmission and reception unit 212A. The radio reception circuit 210B has the same functional configuration as that of the radio reception circuit 210A.

The assembly unit 220 assembles the divided packets. The assembly unit 220 includes packet transmission and reception units 221A and 221B, discard packet extraction units 222A and 222B, an assembly circuit 223, and a packet transmission unit 224.

The packet transmission and reception units 221A and 221B receive the divided packets and the discard packets from radio reception circuits 210A and 210B, respectively. The received packet is, for example, an Ethernet packet. The packet transmission and reception units 221A and 221B are interfaces with the packet transmission and reception units 212A and 212B, respectively. The packet transmission and reception units 221A and 221B transmit the divided packets to the assembly circuit 223. The packet transmission and reception units 221A and 221B transmit the discard packets to the discard packet extraction units 222A and 222B, respectively. The discarded packet extraction units 222A and 222B extract the discard information from the discard packets transmitted from the packet transmission and reception units 221A and 221B, respectively, and notify the assembly circuit 223 of the discard information.

The assembly circuit 223 receives the divided packets from the packet transmission and reception units 212A and 212B for the radio reception circuits 210A and 210B, respectively, and assembles them in the order of the sequence ID described in the overhead of the divided packets. The assembly circuit 223 transmits the assembled packet to the packet transmission unit 224. The assembly circuit 223 receives the discard information from the discard packet generation units 213A and 213B for the radio reception circuits 210A and 210B, respectively, and discard the divided packets based on the discard information. The packet transmission unit 224 transmits packets. The packet to be transmitted is, for example, an Ethernet packet.

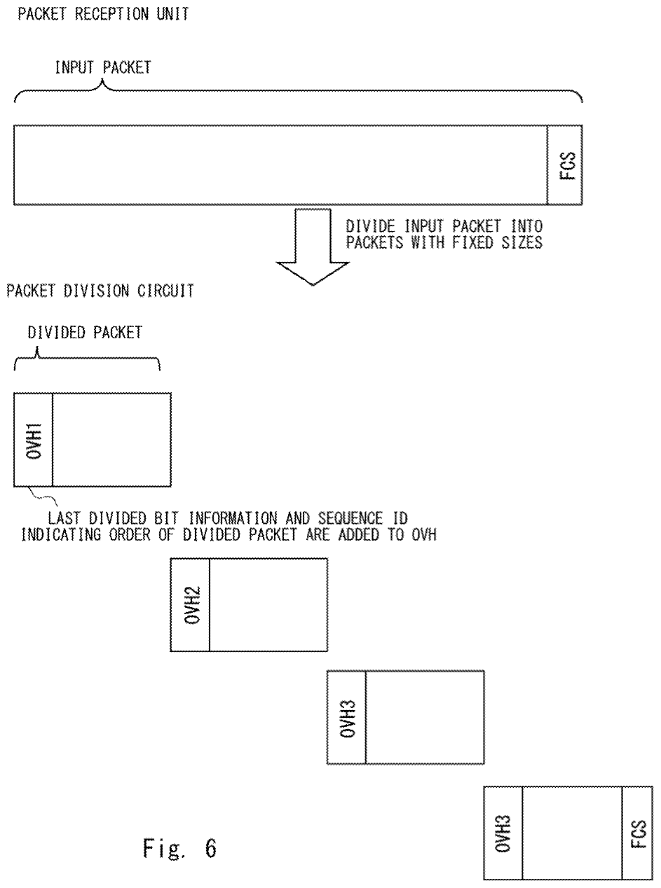

Next, an overview diagram of the generation of the divided packets will be described. FIG. 6 is an overview diagram showing an overview of the generation of the divided packet. After the packet reception unit 111 receives packet from a packet interface, the division circuit 112 divides the received packet into packets with a specified fixed length and transmits the divided packets to the allocation circuit 113. The packet received by the packet reception unit 111 is provided with an FCS (Frame Check Sequence) at the end.

When the packet is divided, the division circuit 112 adds last divided bit information and a sequence ID to the head of the divided data as an overhead. The last divided bit information indicates whether or not the packet is the last divided packet. The details of the overhead will be described later. The divided data provided with the overhead is referred to as a divided packet. FIG. 6 shows an example in which a packet is divided into four packets. The overheads of the divided packets are defined as OVH1, OVH2, OVH3, and OVH4, respectively.

Next, the allocation of the divided packets performed by the allocation circuit 113 will be described in detail. The allocation circuit 113 transmits the divided packets to one of the radio transmission processing units 123A and 123B having the smallest radio transmission delay. Here, the allocation circuit 113 manages the retention amounts of the packet buffers 122A and 122B for the radio transmission processing units 123A and 123B, respectively, and calculates the radio transmission delay based on the retention amounts. The packet transmission and reception units 114A and 114B provided for the radio transmission circuits 120A and 120B transmit the divided packets to the radio transmission circuits 120A and 120B, respectively, via the packet interface.

The condition of the allocation performed by the allocation circuit 113 will be described. As mentioned above, the radio transmission circuit 120A is defined as Main, and the radio transmission circuit 120B is defined as Sub. When the Formula (1) is true, the allocation circuit 113 allocates the divided packets to the radio transmission circuit 120B.

[A]+[B]>[C]+[D] Formula (1):
[A] Radio transmission delay when the next divided packet is transmitted by the radio transmission circuit 120A
[B] Radio transmission delay when all divided packets retained in the packet buffer 122A are wirelessly transmitted
[C] Radio transmission delay when the next divided packet is transmitted by the radio transmission circuit 120B
[D] Radio transmission delay when all divided packets retained in the packet buffer 122B are wirelessly transmitted

Here, [A] and [C] are values that do not include consideration over the retention amount of the packet buffers 122A and 122B. [A] and [C] can be calculated from the radio transmission delay information and the band information. The radio transmission delay information is a value unique to the radio transmission circuits 120A and 120B. The band information is, for example, extracted by the notification packet extraction units 115A and 115B. Hereinafter, a case where the allocation circuit 113 holds the radio transmission delay information as a fixed value will be described. The allocation circuit 113 may appropriately acquire the radio transmission delay information from the radio transmission circuits 120A and 120B.

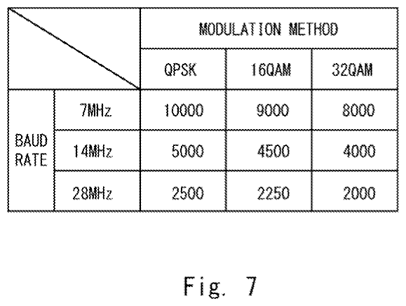

FIG. 7 is a diagram showing an example of the radio transmission delay information. The allocation circuit 113 may store data related to the radio transmission delay shown in FIG. 7 in a tabular form. The radio transmission delay is determined by the baud rate and modulation method. The baud rate is a value indicating the number of times digital data can be modulated per second. The radio transmission circuits 120A and 120B notify the allocation circuit 113 of the baud rate and the modulation method used ,as the band information. The allocation circuit 113 can acquire the radio transmission delay based on the notification.

The allocation unit 113 calculates [B] and [D] based on the retention timing information, the retention information, and band information received from the notification packet extraction unit 115. The calculation method will be described later.

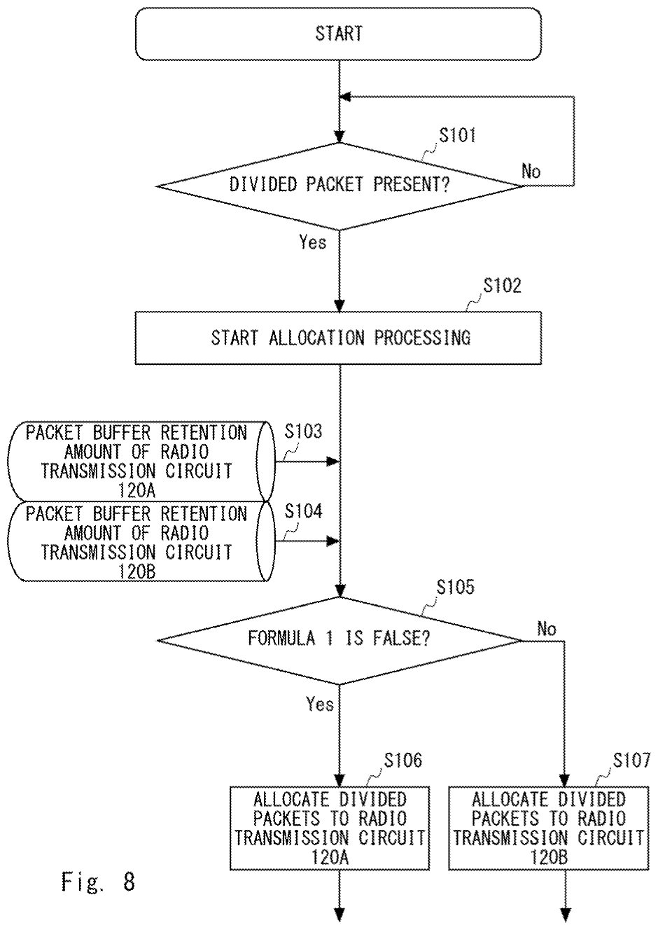

FIG. 8 is a flowchart showing the operation of the allocation circuit 113. The allocation circuit 113 first determines whether or not the divided packets have been received from the division circuit 112 (Step S101). When the divided packets are received (Yes in Step S101), the allocation unit 113 starts allocation processing (Step S102). Next, the allocation unit 113 acquires the retention amount of the packet buffer 122A of the radio transmission circuit 120A as the retention information (Step S103). Next, the allocation unit 113 acquires the retention amount of the packet buffer 122B of the radio transmission circuit 120B as the retention information (Step S104). Next, the allocation unit 113 determines whether the Formula (1) is true or false (Step S105). If Formula (1) is false (Yes in Step S105), the allocation unit 113 allocates the divided packet to the radio transmission circuit 120A (Step S106). If the Formula (1) is true (No in Step S105), the allocation unit 113 allocates the divided packets to the radio transmission circuit 120B (Step S107).

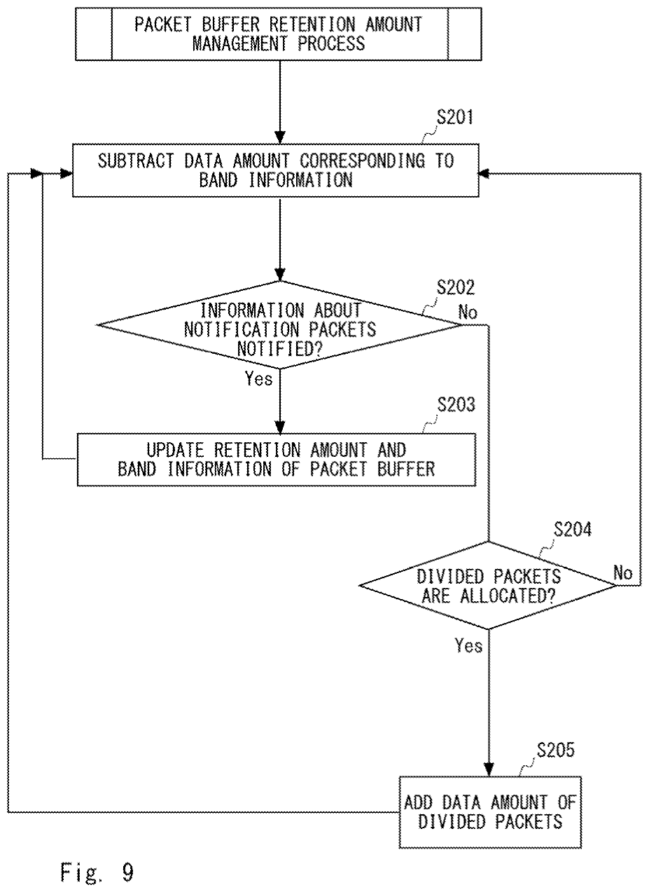

FIG. 9 is a flowchart showing an operation performed when the allocation unit 113 manages the retention amounts of the packet buffers 122A and 122B. Hereinafter, the process shown in FIG. 9 is referred to as a retention amount management process. The retention amount management process is operated for each of the radio transmission circuits 120A and 120B and manages the retention amounts of the packet buffers 122A and 122B.

The allocation unit 113 subtracts the data amount corresponding to the band information from the retention amount (Step S201). Step S201 is for handling a decrease in the retention amount caused by transmission of the divided packets from the packet buffer 122. The data amount corresponding to the band information represents the number of divided packets transmitted from the radio transmission processing unit 123 by the radio transmission delay determined according to the band information. Step S201 may be performed at constant intervals.

Next, the allocation unit 113 determines whether or not the notification packet has been received from the notification packets extraction unit 115 (Step S202). When the notification packets are received (Yes in Step S202), the allocation unit 113 updates the retention information (Step S203), and when the notification packets include the band information, the allocation unit 113 may also update the band information. After the retention amount is updated, the retention amount management process returns to the process of subtracting the retention amount (Step S201).

Next, the allocation circuit 113 determines whether or not the divided packets are allocated to the radio transmission circuits 120A or 120B (Step S204). If the divided packets are not allocated (No in Step S204), the allocation circuit 113 returns to the process of subtracting the retention amount according to the band information (Step S201). When the divided packets are allocated (Yes in Step S204), the allocation unit 113 adds the data amount of the allocated divided packets to the retention information (Step S205). After that, the allocation unit 113 returns to the process of subtracting the retention information according to the band information (Step S201).

Next, the operation of the allocation circuit 113 related to the generation of the discard packets will be described.

When the divided packets are allocated, the allocation circuit 113 holds the radio transmission delay at that time. Due to a decrease in the radio communication band and retention of the packet buffer, the radio transmission delay may increase, and the time at which the divided packets arrive at the assembly circuit 223 may exceed a specified threshold. In such a case, the discard packet generation unit 116 generates the discard information. The discard information is, for example, a sequence ID of a divided packet to be discarded.

The discard information is, for example, a combination of the sequence ID of the first divided packet and the sequence ID of the last divided packet with respect to the packet associated with the delayed divided packet. For example, when a packet is divided into three, the sequence ID of the first divided packet and the sequence ID of the third divided packet are used as the discard information. The discard packet generation unit 116 packetizes the discard information. The discard packet may be in any form as long as it can be distinguished from the divided packet. The allocation circuit 113 may transmit the discard packet to one of the radio transmission circuits 120A and 120B having the smallest radio transmission delay information specific to the radio transmission circuit.

The packet transmission and reception units 114A and 114B arbitrate the divided packets and the discard packets and transmit them to the packet transmission and reception units 121A and 121B of the radio transmission circuits 120A and 120B, respectively. The packet transmission and reception units 114A and 114B receive the notification packets transmitted from the packet transmission and reception units 121A and 121B and transmit them to the notification packet extraction units 115A and 115B, respectively. The notification packet extraction units 115A and 115B extract the retention timing information, the retention information, and band information from the notification packet, and notify the allocation circuit 113 of them.

Next, the operation of the radio transmission circuits 120A and 120B will be described. The packet transmission and reception units 121A and 121B receive the divided packets and the discard packets. The packet transmission and reception units 121A and 121B transmit the divided packets to the packet buffers 122A and 122B, respectively. The packet transmission and reception units 121A and 121B transmit the discard packets to the discard packet extraction units 125A and 125B.

The packet buffers 122A and 122B transmit the divided packets according to radio bands of the radio transmission processing units 123A and 123B, respectively. The packet buffers 122A and 122B notify the notification packet generation units 124A and 124B, respectively, of the retention information about the retention of the divided packet.

The discard packet extraction units 125A and 125B extract the discard information from the discard packet and transmit it to the radio transmission processing units 123A and 123B, respectively. The radio transmission processing units 123A and 123B multiplex the divided packets on a radio frame and perform radio transmission. The discard information is wirelessly transmitted as the overhead of the radio frame. The radio transmission processing units 123A and 123B support the adaptive modulation method, and may notify the notification packet generation units 124A and 124B, respectively, of the band information for each modulation method.

The notification packet generation units 124A and 124B acquire the retention information from the packet buffers 122A and 122B, respectively. The notification packet generation units 124A and 124B acquire the band information from the radio transmission processing units 123A and 123B, respectively. The notification packet generation units 124A and 124B generate the notification packets at a predetermined timing. The predetermined timing is when the retention information exceeds a threshold specifically set or when the band information is changed. The notification packet is composed of the retention timing information related to the timing when an event occurs, the retention information, and the band information. The notification packet may in any form as long as it can be distinguished from the divided packet. The retention timing information includes, for example, the number of clocks at which an event occurs, time information, and the like. The allocation circuit 113 can accurately calculate the retention amount of the divided packets of the packet buffers 122A and 122B using the retention timing information.

Next, the operation of the radio reception circuits 210A and 210B will be described. First, the radio reception units 211A and 211B receive the divided packets from the radio frame. Next, the radio reception units 211A and 211B transmit the divided packets to the packet transmission and reception units 212A and 212B, respectively. The radio reception units 211A and 211B extract the discard information from the overhead of the radio frames and transmit it to the discard packet generation units 213A and 213B, respectively. Next, the packet transmission and reception units 212A and 212B arbitrate the divided packets and the discard packets received from the discard packet generation units 213A and 213B and transmit them to the packet transmission and reception units 221A and 221B, respectively, of the assembly unit 220. The discard packet generation units 213A and 213B packetize the discard information and transmit it to packet transmission and reception units 212A and 212B, respectively.

Next, the operation of the assembly unit 220 will be described.

The packet transmission and reception units 221A and 221B receive the divided packets and the discard packets, transmit the divided packets to the assembly circuit 223, and transmit the discard packets to the discard packet extraction units 222A and 222B, respectively.

The assembly circuit 223 refers to the overheads included at the head of the divided packets and assembles the divided packets in the order of the sequence ID. The assembly circuit 223 transmits the assembled packets to the packet transmission unit 224. The assembly circuit 223 waits for the assembling when the final divided packet is not assembled. That is, the assembly circuit 223 stores the divided packets in the memory inside the assembly circuit 223. The packet transmission unit 224 transmits the packets from the packet interface to the outside. The discard packet extraction units 222A and 222B extract the discard information from the discard packets and notify the assembly circuit of the discard information. The assembly circuit 223 receives the discard information and discards, from the memory, all the divided packets having the sequence ID in the range designated as the discard information.

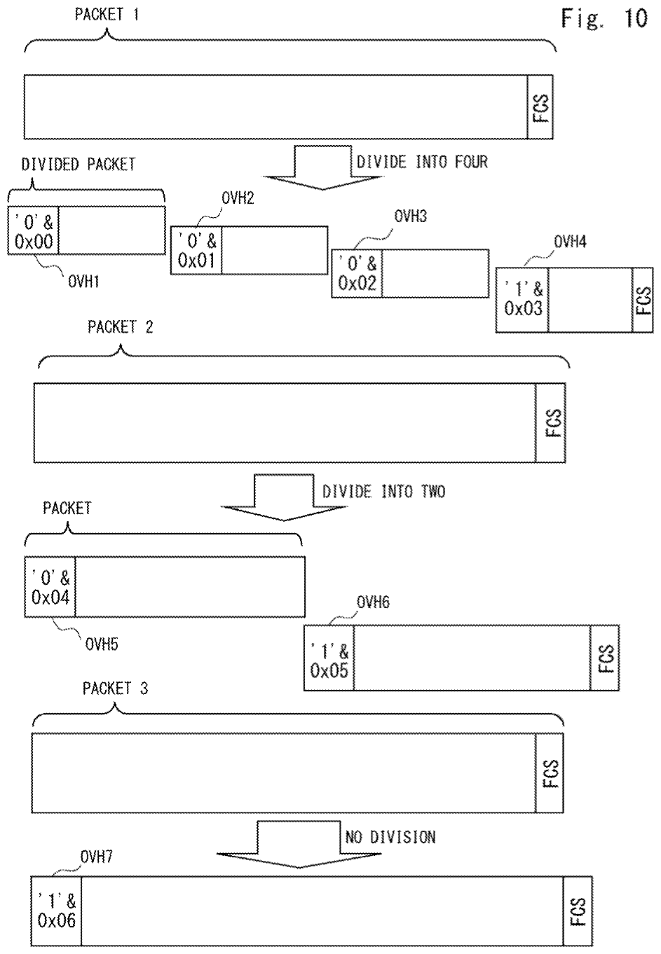

Next, the overhead provided to the divided packet will be described. FIG. 10 is an overview diagram showing an overview of the overhead provided to the divided packet. The division circuit 112 receives packets in the order of the packet 1, the packet 2, and packet 3. Then, the division circuit 112 divides the packet 1 into four, divides the packet 2 into two, and does not divide the packet 3. OVH 1 to 7 are added to the respective divided packets as the overheads. The overhead is a combination of the last divided bit information and the sequence ID. The last divided bit information is information indicating that the divided packet is the last divided packet. For example, the last bit information of the last divided packet is “1”, and the last bit information of the other divided packets is “0”. The last divided bit information of OVH4, OVH6, and OVH7 is “1”. The sequence ID is information indicating the order of the divided packets and is incremented for each divided packet. For example, the sequence ID of the first divided packet may be “0”, and the incremented sequence ID may be used as the sequence ID of the next divided packet.

The data size of the sequence ID may be any size. In the following description, the data size of the sequence ID shall be two bytes. The value for incrementing the sequence ID may be any value. In the following description, the value for incrementing the sequence ID shall be +1. When the packet is divided into four, if the initial value of the sequence ID is 0x00, the sequences ID are 0x00 to 0x03. After that, the sequence ID is incremented by +1, and 0x00 comes after 0xff. The final bit information and the sequence ID enable the assembly circuit 223 to uniquely assemble the divided packets.

Next, a method in which the allocation circuit 113 calculates the radio transmission delay from the retention timing information, the retention information, and the band information will be described. First, when an event affecting the radio transmission delay occurs, the notification packet generation unit 124A or the notification packet generation unit 124B notifies the allocation circuit 113 of the retention timing information, the retention information, and the band information. The events affecting the radio transmission delay are that retention of packets at a threshold or more occurs in the packet buffers 122A and 122B, or that the radio transmission band of the radio transmission circuits 120A and 120B is lowered. As the retention timing information, time synchronization information and the number of clocks may be used.

First, a case where the time synchronization information is used as the retention timing information will be described. First, a protocol such as PTP (Precision Time Protocol)/IEEE 1588 is used to perform time synchronization using the allocation circuit 113 as Master and the radio transmission circuits 120A and 120B as Slave. The time synchronization information is used as the retention timing information.

The allocation circuit 113 acquires time information t2 of the allocation circuit 113 about a time when the notification packet is received. The allocation circuit 113 acquires time information t1 about a time when an event occurs from the retention timing information included in the notification packet. The allocation circuit 113 can calculate an “amount of data corresponding to the number of divided packets allocated to the radio transmission processing units 123A and 123B after the occurrence of the event” (a) based on the difference between the time information t1 and the time information t2. The allocation circuit 113 calculates an “amount of data transmitted from the packet buffers 122A and 122B to the radio transmission processing units 123A and 123B after the occurrence of the event” (b) from the band information based on the difference between the time information t1 and the time information t2.

When the allocation circuit 113 receives the notification packets, the retention amounts of the packet buffers 122A and 122B become “retention information +(a)-(b)”. Thus, the allocation circuit 113 can calculate the radio transmission delay when the divided packets are allocated to the radio transmission circuits 120A and 120B.

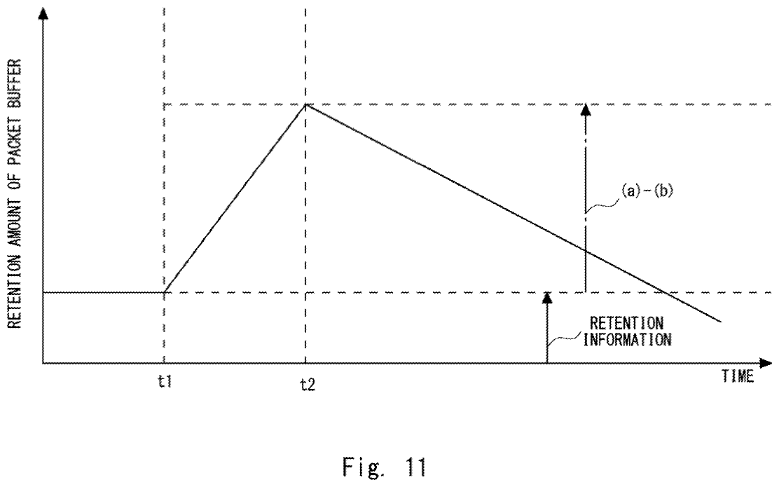

FIG. 11 is an overview diagram showing an example of a change in the retention amount of the packet buffer 122A in the radio transmission circuit 120A. The retention amount is obtained by adding “(a)-(b)” to the retention information. The time t1 indicates the timing of the occurrence of the event affecting the radio transmission delay. The time t2 indicates the timing at which the allocation circuit 113 has received the notification packets. FIG. 11 shows a case where the allocation circuit 113 stops allocating divided packets to the radio transmission circuit 120A at the time t2. The retention amount increases from the time t1 to the time t2. The retention amount decreases from the time t2, because the allocation of the divided packets is stopped at the time t2.

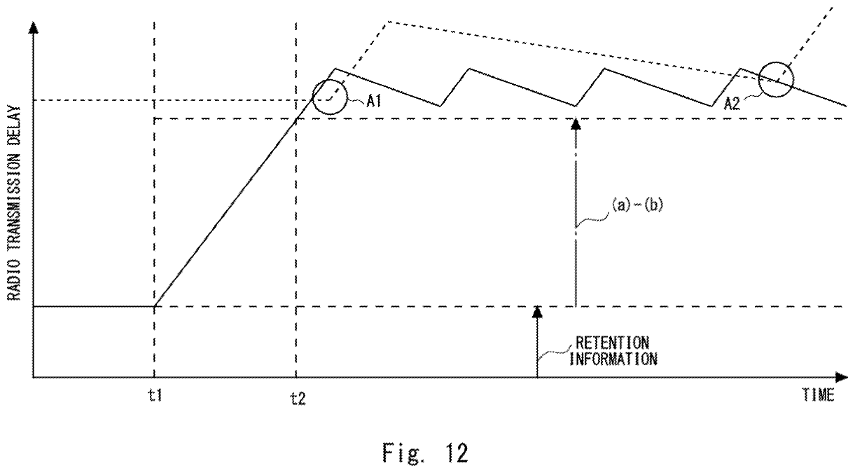

FIG. 12 is an overview diagram showing an overview of the radio transmission delay in the radio transmission circuits 120A and 120B. The radio transmission delay of the radio transmission circuit 120A is indicated by a solid line. The radio transmission delay of the radio transmission circuit 120B is indicated by a dotted line. From the time t1 to time t2, the retention amount increases, and the radio transmission delay increases. At the time t2, since the radio transmission delay of the radio transmission circuit 120A is smaller than the radio transmission delay of the radio transmission circuit 120B, the Formula (1) is false. Thus, the allocation circuit 113 allocates the divided packets to the radio transmission circuit 120A.

By the above-described operation, the retention amount of the packet buffer 122A increases, and the radio transmission delay of the radio transmission circuit 120A increases. Since the condition of the Formula (1) becomes true at A1, the allocation circuit 113 allocates the divided packets to the radio transmission circuit 120B. Thus, from the time of A1 onward, the retention amount of the packet buffer 122B increases, and the radio transmission delay of the radio transmission circuit 120B increases. After that, as the retention amount of the packet buffer 122B decreases, the radio transmission delay of the radio transmission circuit 120B starts to decrease.

At A2, the condition of the Formula (1) becomes true again, and the allocation circuit 113 allocates the divided packets to the radio transmission circuit 120B. By repeating the above operations, the divided packets can be transmitted with the minimum latency.

Next, a case where the number of clocks is used as the retention timing information will be described. In such a case, it is necessary to measure in advance the “number of clocks until the heads of the divided packets reach the packet buffers 122A and 122B from the allocation circuit 113 (c)” and the “number of clocks until the notification packets arrive from the radio transmission circuits 120A and 120B to the allocation circuit 113 (d)”. The notification packet generation units 124A and 124B notify the allocation circuit 113 of the “number of clocks required for writing the divided packets written in the packet buffers 122A and 122B (e)”, respectively, as the retention timing information. The allocation circuit 113 calculates (c)+(d)+(e). By using the number of divided packets (a) allocated between the calculated number of clocks and the amount of data (b) transmitted from the packet buffer between the calculated number of clocks, the allocation circuit 113 can calculate the radio transmission delay in the same manner as when the time synchronization information is used.

In the above example, the case where the division and allocation circuit 110 and the radio transmission circuits 120A and 120B are connected by a serial interface has been described, but this example embodiment is not limited to a serial interface.

Hereinafter, the effect of this example embodiment will be described.

In a radio communication system, a Link Aggregation technique is used in order to widen the transmission bandwidth between radio communication devices. The link aggregation technique is a technique that virtually bundles a plurality of physical lines into one line and enables use of bandwidth depending on a total number of the bands of the physical lines. MRL (Multi Radio-Linc) has been proposed as one of the link aggregation methods to efficiently use the radio band of Multiband. The MRL divides a packet, allocates the divided packets to a plurality of radio communication devices, and transmits them. A radio communication device using an MRL is described in International Patent Publication No. WO2018/116965.

When a serial interface, such as an Ethernet interface, is connected between a circuit for dividing, allocating, or assembling packets and a radio transmission circuit, the radio transmission circuit needs to have a packet buffer. When the radio transmission speed is lowered by the adaptive modulation method, the retention of the divided packets occurs in the packet buffer. When a related technique is used, the allocation circuit cannot calculate an accurate retention amount of the packet buffer of the radio transmission circuit. This leads to a problem that the allocation circuit cannot perform the allocation according to the radio transmission delay, and the radio transmission latency becomes long.

Since the order of the divided packets is not allowed to be changed, the assembly circuit must perform assembling in the order the divided packets are input to the division circuit. Therefore, when the latency of the packets becomes long, the assembly circuit has to wait for the arrival of the packets. Therefore, a packet whose latency has not became long needs to be stored in a memory in the assembly circuit as an assembly waiting state. Thus, when the fluctuation in the amount of the radio transmission delay is large, there is a problem that a large amount of memory resources must be implemented.

In this example embodiment, the retention timing information, the retention information, and the band information are notified to the allocation circuit by the radio transmission circuit. The allocation circuit obtains the radio transmission delay in the retention state from the retention information and the packet amount transmitted to the allocation circuit from the timing indicated in the retention timing information onward.

According to this example embodiment, the retention information of the packet buffer of the radio transmission circuit can be accurately transmitted from the radio transmission circuit to the allocation circuit. This enables the allocation circuit to allocate the divided packets to the radio transmission circuit having the smallest radio transmission delay. In this manner, the radio communication device according to this example embodiment can perform radio transmission with the shortest latency.

Further, according to this example embodiment, the allocation circuit transmits a discard notification to the assembly circuit for the divided packet in which the radio transmission delay has increased to a greater extent than that at the time of allocation. The assembly circuit can discard the divided packet in the assembly waiting state. Thus, according to this example embodiment, it is possible to improve an amount of memory resource consumption and shortage of memory resources in the assembly circuit, thereby reducing the quantity of memory resources to be implemented.

Note that the present disclosure is not limited to the above-described example embodiment, and may be modified as appropriate without departing from the spirit of the disclosure.

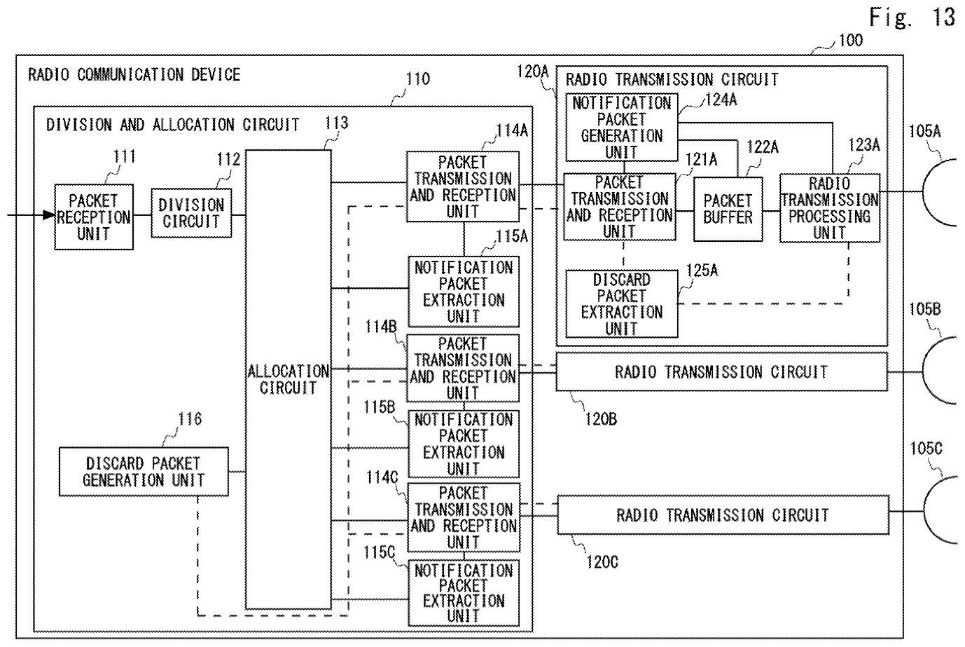

In the above-described example, although the radio communication device 100 has two radio communication means, the same operation can be performed even when three or more radio communication means are included. FIG. 13 is a block diagram of a radio communication device 100 including three radio communication means. The configuration of the radio communication device 100 is the same as that shown in FIG. 4 except that a radio transmission circuit 120C, a packet transmission and reception unit 114C, and a notification packet extraction unit 115C are further included. The radio transmission circuit 120C has the same functional configuration as that of the radio transmission circuits 120A and 120B, and transmits the divided packets using an antenna 105C. The radio transmission circuit 120A is also referred to as Main, the radio transmission circuit 120B is also referred to as Sub1, and the radio transmission circuit 120C is also referred to as Sub2.

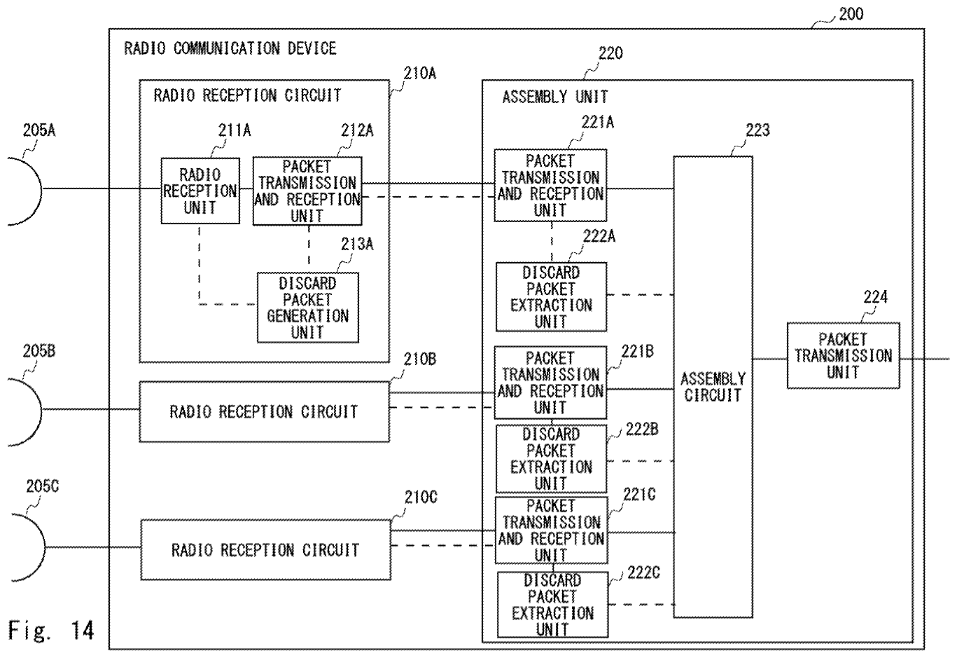

FIG. 14 is a block diagram of a radio communication device 200 including three radio communication means. The operation is the same as that shown in FIG.

5 except for a radio reception circuit 210C, a packet transmission and reception unit 221C, and a discard packet extraction unit 222C. The radio reception circuit 210C has the same functional configuration as that of the radio reception circuits 210A and 210B, and uses an antenna 205C to receive the divided packets.

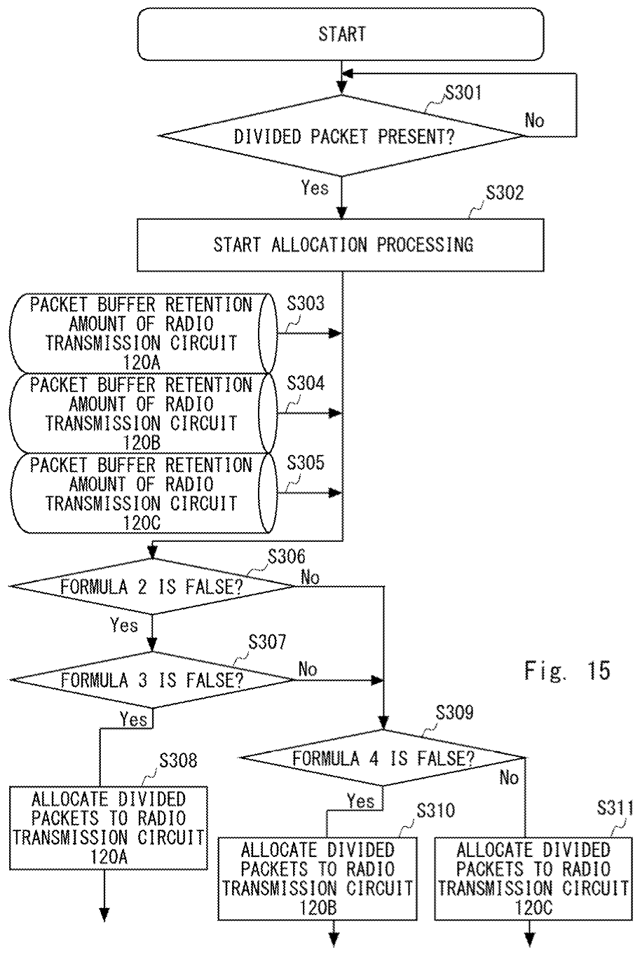

FIG. 15 is a flowchart showing an operation of the allocation circuit 113 when the divided packets are allocated to the three radio communication means. In such a case, the divided packets are allocated according to whether the following Formulas (2), (3), and (4) are true or false.

[A]+[B]>[C1]+[D1]. Formula (2):

[A]+[B]>[C2]+[D2]. Formula (3):

[C1]+[D1]>[C2]+[D2]. Formula (4):
[A] Radio transmission delay when the next divided packet is wirelessly transmitted by Main (radio transmission circuit 120A)
[B] Radio transmission delay when all divided packets retained in the packet buffer 122A of the main are wirelessly transmitted
[C1] Radio transmission delay when the next divided packet is wirelessly transmitted by Sub1 (radio transmission circuit 120B)
[D1] Radio transmission delay when all divided packets retained in the packet buffer 122B of Sub1 are wirelessly transmitted
[C2] Radio transmission delay when the next divided packet is wirelessly transmitted by Sub2 (radio transmission circuit 120C)
[D2] Radio transmission delay when all the divided packets retained in the packet buffer 122C of the Sub2 are transmitted wirelessly

Steps S301 to S304 of FIG. 15 are the same as Steps S101 to S104 of FIG. 8, respectively. In Step S305, the allocation circuit 113 acquires the number of divided packets retained in the packet buffer 122C of the radio transmission circuit 120C.

In Step S306, it is determined whether the Formula (2) is true or false. If the Formula (2) is false (Yes in Step S306), the allocation unit 113 determines whether the Formula (3) is true or false (Step S307). If Formula (2) is true (No in Step S306), the allocation unit 113 proceeds to Step S309.

If the Formula (3) is false (Yes in Step S307), the allocation unit 113 allocates the divided packets to the radio transmission circuit 120A. If the Formula (3) is true (No in Step S307), the process proceeds to Step S309.

In Step S309, if the Formula (4) is false (Yes in Step S309), the allocation unit 113 allocates the divided packet to the radio transmission circuit 120B (Step S310). In Step S309, if the Formula (4) is true (No in Step S309), the allocation unit 113 allocates the divided packets to the radio transmission circuit 120C (Step S311).

A case where four or more radio communication means are included will be described. When four or more radio communication means are included, an index is provided to Sub radio communication means. In the above example, 1 and 2 are indices for Sub1 and Sub2, respectively. When four or more radio communication means are added, a comparison expression with the radio communication means of the Main corresponding to the Formula (2) and a comparison expression with the radio communication means of the small index (Sub) are added to the Formulas (2) to (4). By using the added Formulas and Formulas (2) to (4), the allocation circuit 113 can perform allocation appropriately.

According to the present disclosure, it is possible to provide a radio communication device, a radio communication system, and a radio communication method capable of notifying a radio communication unit of retention information of divided packets retained in a radio communication unit and allocating the divided packets based on the notification.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A radio communication device comprising:
a plurality of radio transmission units each including a buffer for storing a transmission packet to be transmitted;
a division unit configured to divide an input packet into a plurality of transmission packets;
a retention information notification unit configured to notify about retention information of the transmission packets retained in the buffer; and
an allocation unit configured to allocate the transmission packets to at least one of the plurality of radio transmission units based on the notified retention information.

2. The radio communication device according to claim 1, wherein
the allocation unit is configured to calculate a radio transmission delay caused by passing through the radio transmission unit based on the notified retention information, and allocate the transmission packets to the radio transmission unit having a minimum radio transmission delay among the plurality of radio transmission units.

3. The radio communication device according to claim 1, wherein
the retention information notification unit is configured to notify the allocation unit of the retention timing information related to a timing at which the retention information is acquired.

4. The radio communication device according to claim 1, wherein
the retention information notification unit is configured to notify the allocation unit of the retention information of the radio transmission unit whose radio transmission speed has decreased when the radio transmission speed of at least one of the plurality of radio transmission units has decreased.

5. The radio communication device according to claim 2, further comprising a discard information notification unit configured to notify about discard information designating the transmission packet to be discarded when the radio transmission delay exceeds a predetermined threshold.

6. A radio communication system comprising:
a first radio communication device that includes
a plurality of radio transmission units each including a buffer for storing a transmission packet to be transmitted,
a division unit configured to divide an input packet into a plurality of transmission packets,
a retention information notification unit configured to notify about retention information of the transmission packets retained in the buffer,
and an allocation unit configured to allocate the transmission packets to at least one of the plurality of radio transmission units based on the notified retention information; and
a second radio communication device that includes
a plurality of radio reception units configured to receive the transmission packets transmitted by the plurality of radio transmission units, and
an assembly unit configured to reproduce the packet from the transmission packets.

7. The radio communication system according to claim 6, wherein
the allocation unit is configured to calculate a radio transmission delay caused by passing through the radio transmission unit based on the notified retention information, and allocate the transmission packet to the radio transmission unit having a minimum radio transmission delay among the plurality of radio transmission units.

8. A radio communication method comprising:
dividing an input packet into a plurality of transmission packets;
notifying about retention information of the transmission packets retained in a buffer for storing the transmission packets; and
allocating the transmission packets to at least one of a plurality of radio transmission units each including a buffer based on the notified retention information.

9. The radio communication method according to claim 8, further comprising calculating a radio transmission delay caused by passing through the radio transmission unit based on the notified retention information, and allocating the transmission packet to the radio transmission unit including a minimum radio transmission delay among the plurality of radio transmission units.
